(19) United States
(12) Patent Application Publication
(10) Pub. No.: US 2008/0076694 A1
(43) Pub. Date: Mar. 27, 2008

(54) Granular surfactant compositions, methods of making and uses thereof

(76) Inventors: Sabine Both, Neuss (DE); Corinna Boehme, Dormagen (DE); Rainer Eskuchen, Langenfeld (DE); Hans-Christian Raths, Monheim (DE); Susan Fleet-Brandt, Aachen (DE)

Correspondence Address: COGNIS CORPORATION;PATENT DEPARTMENT, 300 BROOKSIDE AVENUE, AMBLER, PA, 19002, US

(21) Appl. No.: 11/820,951

(22) Filed: Jun. 21, 2007

(30) Foreign Application Priority Data
Jun. 24, 2006 (DE) 10 2006 029 007.0

(51) Int. Cl. C11D 1/00; C11D 17/00

(52) U.S. Cl. 510/445; 510/535

(57) ABSTRACT

Surfactant granules, of which the grain size distribution as determined by RRSB graph to DIN 66145 possess the following parameters: dₘ is in the range from 0.5 to 1.5 mm; d_{63.3} is in the range from 0.5 to 1.5 mm; and n is in the range from 1 to 10, show advantageous performance properties, for example in the production of detergents, for example, automatic dish and laundry detergents.

### CROSS REFERENCE TO RELATED APPLICATIONS

This application claims priority under 35 U.S.C. Section 119 of German patent application No. 1020060290070.0 filed Jun. 24, 2006, the contents of which is incorporated herein in its entirety.

### FIELD OF THE INVENTION

This invention relates to solid granular compositions which contain surfactants and which are characterized by a specific grain size distribution, to a process for their production and to the use of the compositions in detergents.

### BACKGROUND OF THE INVENTION

Surfactant components for use in detergents are normally supplied in the form of a solid block, as a molten paste, or in liquid or in powder form. The surfactant raw materials supplied in the form of a solid block generally have to be melted before further processing which entails an additional process step and more energy consumption. Powders have the disadvantage that more dust can be formed and the effect of the surfactant is lost, for example, by over-rapid dissolution in the water. If the surfactant raw material is supplied in the form of a pre-melted liquid, it has to be expensively pumped off, heated and, in general, rapidly further processed. This, too, involves the manufacturer in costs. Accordingly, there is a demand for surfactant raw materials in a dust-free, readily pourable, solid supply form. Granular supply forms would be suitable for this purpose. Although such granules are known in principle, it has been found in practice that further processing results in unfavorable performance properties, for example, to problems with the solubility of the detergents or to a reduction in the clear-rinse performance of dish detergents.

Now, the problem addressed by the present invention was to convert surfactant raw materials into a granular form that would be easy to store, transport, and further process without any disadvantages or poor performance arising during subsequent incorporation and further processing to detergents.

It has been now found that granules with a certain selected grain size distribution solve the problems described above.

Surfactants in granular supply forms with a selected grain size distribution are known from the prior art, cf. for example EP 0 249 163 A2 which relates to detergents containing granular agglomerated sodium metasilicate. According to the teaching of this document, preferred detergents are characterized in that the grains are smaller than 0.4 mm and the mean particle diameter (as determined to DIN 66145) is in the range from 0.9 to 1.3 mm, and the gradient N of the RRSB line being from 2 to 2.5.

However, this document does not disclose purely surface-active granular raw materials, but agglomerated compounds which, in addition, contain only sodium metasilicate and builders, but not surfactants.

### SUMMARY OF THE INVENTION

Accordingly, in a first embodiment, the present invention is directed to solid granular compositions containing at least one surfactant, wherein, according to sieve analysis with a sieve conforming to DIN ISO 3310-1, the granular composition has a grain size distribution, the grain size distribution as determined by RRSB graphs to DIN 66145 having the following parameters:
dₘ is in the range from 0.5 to 1.5 mm;
d_{63.3} is in the range from 0.5 to 1.5 mm and
n is in the range from 1 to 10.

In another aspect of the invention, the solid granular compositions are suitable for use in solid cleaning compositions, particularly detergent compositions.

### DETAILED DESCRIPTION OF THE INVENTION

It is known that so-called sieve analysis represents a proven method for characterizing granules. Numerous methods are known to experts for characterizing particle systems and particularly their size distribution. The particle size distribution of real particle systems is generally determined by measurement. Initially, this gives pairs of measured values which, with modern measuring instruments, are stored in digital form. The recording of the value pairs in the form of a graph gives the distribution density or distribution sum function. The number of value pairs is established by the measuring technique or by settings and, with some measuring techniques, can amount to a few hundred. In most cases, the results are directly further processed in digital form. In many cases, however, efforts are also made to determine the particle size distribution by a suitable distribution function which, at the same time, is intended to represent a compensating function for the measured values. A commonly used empirical distribution function is the so-called RRSB function.

Determining whether or not a group of particles has an RRSB distribution is carried out by the DIN 66145 method. Key parameters which are used to describe an RRSB grain size distribution are the mean diameter dₘ, the characteristic grain size d_{63.3} and the so-called uniformity coefficient ₙ.

By way of the present invention, it is now shown that particulate surfactant systems, which have a mean diameter of 0.5 to 1.5 mm, a characteristic grain size of 0.5 to 1.5 mm and, at the same time, a uniformity coefficient of 1 to 10, exhibit advantageous performance properties.

Granular compositions where dₘ is in the range from 0.5 to 1.2 mm, d_{63.3} is in the range from 0.5 to 1 mm and n is in the range from 1 to 5 are particularly preferred.

The granular compositions according to the present invention contain surfactants and, preferably, are comprised solely of surfactants and, in a particularly preferred embodiment, of a single class of surfactants.

Granules are normally described as accumulations of grains. A grain is an asymmetrical aggregate of powder particles (whole crystals or crystal fragments). In contrast to pellets, but like an agglomerate, it does not have a harmonious geometric form; the form of a sphere, a rodlet, a cylinder, etc. is only approximately and allusively obtained. The surface is generally uneven and indented, the mass often more or less porous. Granulation is understood to be the conversion of powder particles into grains. Technical embodiments frequently make use of fluidized bed processes—the term “prills” is often used today.

With regard to the surfactants present in the compositions according to the invention, any known surfactants which are solid at room temperature (21° C.) may be used. Accordingly, this includes anionic, cationic, nonionic and amphoteric surfactants. However, nonionic surfactants are particularly preferred.

The granules according to the invention preferably contain nonionic surfactants. Granules formed from only one surfactant are preferred. Such granules according to the invention contain the surfactant in its technical quality, so that impurities or residues of starting compound may be present. Granules which are formed from solely of the desired surfactant or the desired surfactant mixtures are particularly preferred.

Typical examples of suitable nonionic surfactants are alkoxylates of alkanols, end-capped alkoxylates of alkanols with no free OH groups, alkoxylated fatty acid lower alkyl esters, amine oxides, alkylphenol polyglycol ethers, fatty acid polyglycol esters, fatty acid amide polyglycol ethers, fatty amine polyglycol ethers, alkoxylated triglycerides, mixed ethers and mixed formals, fatty acid-N-alkyl glucamides, protein hydrolyzates (more particularly wheat-based vegetable products), polyol fatty acid esters, sugar esters, sorbitan esters and polysorbates. If the nonionic surfactants contain polyglycol ether chains, they may have a conventional homolog distribution although they preferably have a narrow homolog distribution. Other suitable nonionic surfactants for use in the invention are the alkoxylates of alkanols, more particularly fatty alcohol polyethylene glycol/polypropylene glycol ethers (FAEO/PO) or fatty alcohol polypropylene glycol/polyethylene glycol ethers (FAPO/EO), end-capped alkoxylates of alkanols, more particularly end-capped fatty alcohol polyethylene glycol/polypropylene glycol ethers or end-capped fatty alcohol polypropylene glycol/polyethylene glycol ethers, and fatty acid lower alkyl esters and amine oxides. In addition, alkyl and/or alkenyl oligoglycosides may also be used.

The nonionic surfactants may be present in the detergents according to the invention in quantities of 0.1 to 15% by weight, preferably in quantities of 0.5 to 10% by weight, and more particularly in quantities of 1 to 8% by weight, expressed as active substance and based on the detergent.

Preferred substances for the granules according to the invention are nonionic surfactants selected from classes a) to i).

The nonionic surfactants of class a) are selected from compounds corresponding to general formula (I):
R¹O[CH₂CH₂O]ₓCH₂CH(OM)R² (I)
in which R¹ is a linear or branched alkyl and/or alkenyl group containing 4 to 22 carbon atoms or an R²—CH(OH)CH₂ group, where R² is a linear or branched alkyl and/or alkenyl group containing 8 to 16 carbon atoms, x is a number of 40 to 80 and M is a hydrogen atom or a saturated alkyl group containing 1 to 18 carbon atoms. These compounds are so-called hydroxy mixed ethers or derivatives thereof. Hydroxy mixed ethers (HMEs) correspond to the broad general formula R′O[AO]ₓCH₂CH(OM)R″, in which R′ is a linear or branched alkyl and/or alkenyl group containing 4 to 22 carbon atoms, R″ is a linear or branched alkyl and/or alkenyl group containing 2 to 22 carbon atoms, x has a value of 10 to 80, AO is an ethylene oxide, propylene oxide or butylene oxide group and M can be a hydrogen atom, or an alkyl or alkenyl group.

Hydroxy mixed ethers of the type in question are known from the literature and are described, for example, in German patent application DE 19738866. They are prepared, for example, by reaction of 1,2-epoxyalkanes (R″CHOCH₂), where R″ is an alkyl and/or alkenyl group containing 2 to 22 and more particularly 6 to 16 carbon atoms, with alkoxylated alcohols. Hydroxy mixed ethers preferred for the purposes of the invention are those derived from alkoxylates of monohydric C₄₋₁₈ alcohols with the formula R′—OH, R′ being an aliphatic, saturated, linear or branched alkyl group, more particularly containing 6 to 16 carbon atoms. Examples of suitable straight-chain alcohols are butan-1-ol, caproic alcohol, oenanthic alcohol, caprylic alcohol, pelargonic alcohol, capric alcohol, undecan-1-ol, lauryl alcohol, tridecan-1-ol, myristyl alcohol, pentadecan-1-ol, palmityl alcohol, heptadecan-1-ol, stearyl alcohol, nonadecan-1-ol, arachidyl alcohol; heneicosan-1-ol, behenyl alcohol, and the technical mixtures thereof obtained in the high-pressure hydrogenation of technical methyl esters based on fats and oils. Examples of branched alcohols are so-called oxo alcohols which generally contain 2 to 4 methyl groups as branches and are produced by the oxo process and the Guerbet alcohols which are branched in the 2-position by an alkyl group. Suitable Guerbet alcohols are 2-ethyl hexanol, 2-butyl octanol, 2-hexyl decanol and/or 2-octyl dodecanol. The alcohols are used in the form of their alkoxylates which are prepared in known manner by reaction of the alcohols with ethylene oxide.

There are also other known hydroxy mixed ethers, namely those which contain more than one free hydroxyl group in the molecule. Such compounds can be prepared, for example, by reacting diols, preferably alkylene glycols and derivatives thereof, preferably polyethylene glycols, With two mols of an alkyl epoxide (R—CHOCH₂) per mol of the diol.

The surfactants of class b), which are also suitable, are selected from the group of compounds corresponding to formula (II):
R³O[CH₂CH₂O]_{y}[CH₂CHCH₃O]_{z}CH₂CH(OH)R⁴ (II)
in which R³ is a linear or branched alkyl and/or alkenyl group containing 8 to 22 carbon atoms, R⁴ is a linear or branched alkyl and/or alkenyl group containing 8 to 16 carbon atoms, y is a number of 10 to 35, z=0 or a number of 1 to 5, with the proviso that, where R³═R¹ and at the same time R⁴═R², z must be at least 1.

These compounds are also HMEs, but with a structure different from that of the HMEs of general formula (I). The compounds of type b) correspond to formula (Il):
R³O[CH₂CHCH₃O]_{z}[CH₂CH₂O]_{y}CH₂CH(OH)R⁴ (II)
in which R³ is a linear or branched alkyl and/or alkenyl group containing 8 to 22 carbon atoms, R⁴ is a linear or branched alkyl and/or alkenyl group containing 8 to 16 carbon atoms, y is a number of 10 to 35, z is 0 or must have a value of 1 to 5. It can be advantageous if, where R³═R¹ and at the same time R⁴═R², the compounds of formula b) selected are those in which the index x is at least 1. Particularly preferred compounds of type b) are, for example, those in which, in formula (II), the index y is a number of 20 to 30 and preferably 20 to 25. Other preferred compounds of type b) are those in which, in formula (II), R³is an alkyl group containing 8 to 12 and preferably 8 to 10 carbon atoms, R⁴ is an alkyl group containing 10 to 12 and preferably 10 carbon atoms, y is a number of 15 to 35, preferably 20 to 30, and z is a number of 1 to 3, preferably 1.

Also suitable are c) ethoxylated fatty alcohols corresponding to general formula (III):
R⁵—(OC₂H₄)_{z}—OH (III)
in which R⁵ represents linear or branched alkyl and/or alkenyl groups containing 8 to 22 carbon atoms and z is a number of 1 to 20.

These compounds are fatty alcohol ethoxylates corresponding to general formula (III) R⁵—(OC₂H₄)_{z}—OH, in which R⁵ represents linear or branched alkyl and/or alkenyl groups containing 8 to 22 carbon atoms and z is a number of 1 to 20, preferably 1 to 15, and more particularly 1 to 10. Typical examples are the adducts of on average 1 to 20 mol caproic alcohol, caprylic alcohol, 2-ethylhexyl alcohol, capric alcohol, lauryl alcohol, isotridecyl alcohol, myristyl alcohol, cetyl alcohol, palmitoleyl alcohol, stearyl alcohol, isostearyl alcohol, oleyl alcohol, elaidyl alcohol, petroselinyl alcohol, archly alcohol, gadoleyl alcohol, behenyl alcohol, erucyl alcohol, and brassidyl alcohol, and the technical mixtures thereof obtained, for example, in the high-pressure hydrogenation of technical methyl esters based on fats and oils or aldehydes from Roelen's oxo synthesis and as monomer fraction in the dimerization of unsaturated fatty alcohols. Adducts of 10 to 40 mol ethylene oxide with technical C₁₂₋₁₈ fatty alcohols, such as for example coconut oil, palm oil, palm kernel oil, or preferably tallow fatty alcohol, are preferred. Particularly preferred fatty alcohol ethoxylates are based on tallow fatty alcohols ethoxylated with 2 to 10, and preferably 2 to 5 mol ethylene oxide per mol alcohol.

Also suitable are substances of group d) which correspond to the formula
R⁶CO—(OC₂H₄)ₘ—OR⁷,
in which R⁶ is an alkyl and/or alkenyl group containing 7 to 21 carbon atoms, m is a number of 11 to 100 and R⁷ is a hydrogen atom or a CO—R⁶ group. These compounds are mono- and/or preferably diesters of glycol and especially polyglycols and are also known and commercially available. They correspond to the formula R⁶CO—(OC₂H₄)ₘ—OR⁷, in which R⁶ is an alkyl and/or alkenyl group containing 7 to 21 carbon atoms, m is a number of 11 to 100 and R⁷ is a hydrogen atom or a CO—R⁶ group. The formula encompasses symmetrical (R⁶═R⁷) and asymmetrical compounds (R⁶≠R⁷). Compounds of type d) based on polyethylene glycols with molecular weights of 1,000 to 10,000, preferably 1,500 to 6,000, and more particularly 1500 to 3,000 are preferably used in the preparations according to the invention. Diester compounds of type d) are particularly preferred. Besides compounds of type d), polyglycols may also be present as secondary products from the production process.

Also suitable are compounds of type e), namely alkyl (oligo)glycosides corresponding to the general formula R⁸O-[G]ₚ, where R⁸ is an alkyl and/or alkenyl group containing 4 to 22 carbon atoms, G is a sugar unit containing 5 or 6 carbon atoms and p is a number of 1 to 10.

These compounds are also known as alkyl (oligo)glycosides. Alkyl and alkenyl oligoglycosides are known nonionic surfactants which correspond to the above formula R⁸O-[G]ₚ. They may be obtained by the methods well-known in the art. The alkyl and/or alkenyl oligoglycosides may be derived from aldoses or ketoses containing 5 or 6 carbon atoms, preferably glucose. Accordingly, the preferred alkyl and/or alkenyl oligoglycosides are alkyl and/or alkenyl oligoglucosides. The index p in the general formula indicates the degree of oligomerization (DP), i.e. the distribution of mono- and oligoglycosides, and is a number of 1 to 10. Whereas p in a given compound must always be an integer and, above all, may assume a value of 1 to 6, the value p for a certain alkyl oligoglycoside is an analytically determined calculated quantity which is generally a broken number. Alkyl and/or alkenyl oligoglycosides having an average degree of oligomerization p of 1.1 to 3.0 are preferably used. Alkyl and/or alkenyl oligoglycosides, having a degree of oligomerization of less than 1.7 and, more particularly, between 1.2 and 1.4, are preferred. The alkyl or alkenyl radical R⁸ may be derived from primary alcohols containing 4 to 11 and preferably 8 to 10 carbon atoms. Typical examples are butanol, caproic alcohol, caprylic alcohol, capric alcohol and undecyl alcohol, and the technical mixtures thereof obtained, for example, in the hydrogenation of technical fatty acid methyl esters or in the hydrogenation of aldehydes from Roelen's oxosynthesis. Alkyl oligoglucosides having a chain length of C₈ to C₁₀ (DP=1 to 3), which are obtained as first runnings in the separation of technical C₈₋₁₈ coconut oil fatty alcohol by distillation and which may contain less than 6% by weight of C₁₂ alcohol as an impurity, and also alkyl oligo-glucosides based on technical C_{9/11} oxoalcohols (DP=1 to 3) are preferred. In addition, the alkyl or alkenyl radical R⁸ may also be derived from primary alcohols containing 12 to 22 and preferably 12 to 14 carbon atoms. Typical examples are lauryl alcohol, myristyl alcohol, cetyl alcohol, palmitoleyl alcohol, stearyl alcohol, isostearyl alcohol, oleyl alcohol, elaidyl alcohol, petroselinyl alcohol, arachyl alcohol, gadoleyl alcohol, behenyl alcohol, erucyl alcohol, brassidyl alcohol and technical mixtures thereof which may be obtained as described above. Alkyl oligoglucosides based on hydrogenated C_{12/14} cocoalcohol with a DP of 1 to 3 are preferred.

Also suitable are compounds of type f), the betaines. Betaines are known surfactants which are mainly produced by carboxyalkylation, preferably carboxymethylation, of aminic compounds. The starting materials are preferably condensed with halocarboxylic acids or salts thereof, more particularly with sodium chloroacetate, one mol salt being formed per mol betaine. The addition of unsaturated carboxylic acids, such as acrylic acid for example, is also possible. Examples of suitable betaines are the carboxyalkylation products of secondary and, in particular, tertiary amines corresponding to formula (1): 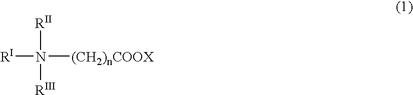
in which R^{I} stands for alkyl and/or alkenyl groups containing 6 to 22 carbon atoms, R^{II} stands for hydrogen or alkyl groups containing 1 to 4 carbon atoms, R^{III} stands for alkyl groups containing 1 to 4 carbon atoms, n is a number of 1 to 6 and X is an alkali metal and/or alkaline earth metal or ammonium. Typical examples are the carboxymethylation products of hexyl methyl amine, hexyl dimethyl amine, octyl dimethyl amine, decyl dimethyl amine, dodecyl methyl amine, dodecyl dimethyl amine, dodecyl ethyl methyl amine, C_{12/14} cocoalkyl dimethyl amine, myristyl dimethyl amine, cetyl dimethyl amine, stearyl dimethyl amine, stearyl ethyl methyl amine, oleyl dimethyl amine, C_{16/18} tallow alkyl dimethyl amine, and technical mixtures thereof.

Other suitable betaines are carboxyalkylation products of amido-amines corresponding to formula (2): 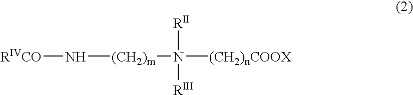
in which R^{IV}CO is an aliphatic acyl group containing 6 to 22 carbon atoms and 0 or 1 to 3 double bonds, m is a number of 1 to 3 and R^{II}, R^{III}, n and X are as defined above. Typical examples are reaction products of fatty acids containing 6 to 22 carbon atoms, namely caproic acid, caprylic acid, capric acid, lauric acid, myristic acid, palmitic acid, palmitoleic acid, stearic acid, isostearic acid, oleic acid, elaidic acid, petroselic acid, linoleic acid, linolenic acid, elaeostearic acid, arachic acid, gadoleic acid, behenic acid and erucic acid and technical mixtures thereof, with N,N-dimethyl aminoethyl amine, N,N-dimethyl aminopropyl amine, N,N-diethyl aminoethyl amine and N,N-diethyl aminopropyl amine which are condensed with sodium chloroacetate. It is preferred to use a condensation product of C_{8/18} cocofatty acid-N,N-dimethyl aminopropyl amide with sodium chloroacetate.

Other suitable starting materials for the betaines to be used in accordance with the invention are imidazolines corresponding to formula (3): 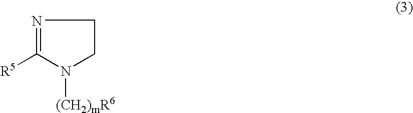
in which R⁵ is an alkyl group containing 5 to 21 carbon atoms, R⁶ is a hydroxyl group, an OCOR⁵ or NHCOR⁵ group and m=2 or 3. Imidazolines are also known compounds which may be obtained, for example, by cyclizing condensation of 1 or 2 mol of fatty acid with polyfunctional amines, for example aminoethyl ethanolamine (AEEA) or diethylene triamine. The corresponding carboxyalkylation products are mixtures of different open-chain betaines. Typical examples are condensation products of the above-mentioned fatty acids with AEEA, preferably imidazolines based on lauric acid or C_{12/14} cocofatty acid, which are subsequently betainized with sodium chloroacetate.

Another suitable class of compounds are g) compounds corresponding to general formula (IV): 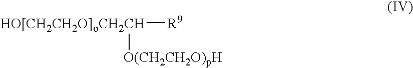
in which R⁹ is a linear or branched alkyl and/or alkenyl group containing 4 to 22 carbon atoms, o is a number of 1 to 20 and the index p is 0 or a number of 1 to 20. These also known nonionic compounds are prepared, for example, by reacting alkyl epoxides with ethylene glycol and then with more ethylene oxide.

Also suitable are compounds corresponding to general formula (V):
R¹⁰CH(OR¹¹)CH₂—OR¹¹ (V)
in which R¹⁰ is a saturated or unsaturated, branched or unbranched alkyl or alkenyl group containing 8 to 16 carbon atoms and the substituents R¹¹ independently of one another represent a group (CH₂CH₂O)ᵣCH₂CH(OH)R¹², in which r in each of the R¹¹ substituents independently stands for 0 or a number of 1 to 50 and R¹² is a saturated or unsaturated, branched or unbranched alkyl or alkenyl group containing 8 to 16 carbon atoms.

Further suitable compounds are i) compounds corresponding to general formula (VI):
NR¹³₃ (VI)
in which the substituents R¹³ independently of one another represent a group (CH₂CH₂O)ₛ—CH₂CH(OH)R¹⁴ or an alkyl group containing 8 to 16 carbon atoms and s in each substituent R¹³ independently represents 0 or a number of 1 to 50.

Accordingly, preferred compositions are those which contain only nonionic surfactants from one of classes a) to i) described above. Compositions which contain only class a) and/or class b) surfactants are particularly preferred for use in the present invention.

Besides the surfactants described above, the compositions may contain other additives, preferably polymers. The percentage content of these additives is generally at most 10%, based on the granular compositions, and preferably between 1 and 5% by weight.

The granulated surfactant preparations according to the present invention are preferably used as a starting product for the production of solid detergents.

Besides the granulated preparations, the fully formulated detergents preferably contain as further constituents other surfactants, preferably anionic surfactants, soaps, inorganic builders, such as phosphates, zeolites, crystalline layer silicates, amorphous silicates, compounds of amorphous silicates and carbonates, organic co-builders, bleaching agents and bleach activators, foam inhibitors, enzymes, optical brighteners, soil repellents and redeposition inhibitors.

Solid detergents according to the present invention, i.e. those containing solid preparations as. described above, contain the compositions of the invention in quantities of 0.1 to 25% by weight, preferably in quantities of 0.5 to 15% by weight, and more particularly in quantities of 1.0 to 5.0% by weight, based on the total weight of the detergent. Particularly preferred detergents according to the present invention are hard surface cleaners and more particularly, automatic dish detergents.

In principle, the solid preparations according to the invention may be produced by any method known in the art. Fluidized bed granulation and extrusion methods are preferred.

Fluidized bed or SKET granulation is understood to be a simultaneous granulation and drying process preferably carried out in batches or continuously. The nonionic surfactants may be introduced into the fluidized bed simultaneously or successively through one or more nozzles, preferably in the form of water-containing pastes. Preferred fluidized-bed arrangements have base plates measuring 0.4 to 5 m. The SKET granulation is preferably carried out at fluidizing air flow rates of 1 to 8 m/s. The granules are preferably discharged from the fluidized bed via a sizing stage. Sizing may be carried out, for example, by means of a sieve or by an air stream flowing in countercurrent (sizing air) which is controlled in such a way that only particles beyond a certain size are removed from the fluidized bed while smaller particles are retained in the fluidized bed. The inflowing air is normally made up of the heated or unheated sizing air and the heated bottom air. The temperature of the bottom air is between 60 and 400° C. and preferably between 60 and 350° C. A starting material in the form of an organic polymeric carrier material or SKET granules from an earlier test batch is advantageously introduced at the beginning of the granulation process. In the fluidized bed, the water evaporates from the surfactant paste which, besides the surfactant, also contains the polymer, resulting in the formation of partly or fully dried cores which are coated with more surfactant/polymer mixture, granulated and simultaneously dried. The end product is a surfactant/polymer grain with a surfactant gradient through the grain which is particularly soluble in water. The simultaneous granulation and drying can be carried out without the addition of inorganic salts, such as zeolite and soda, for example.

In a preferred embodiment, a solid preparation according to the invention is produced by extrusion. In this extrusion process, a solid premix is extruded under pressure to form a strand and, after emerging from the multiple-bore extrusion die, the strands are cut into granules of predetermined size by means of a cutting unit. The solid, homogeneous premix optionally contains a plasticizer and/or lubricant of which the effect is to soften the premix under the pressure applied or under the effect of specific energy, so that it can be extruded. Preferred plasticizers and/or lubricants are surfactants and/or polymers.

The premix is preferably delivered to a planetary roll extruder or to a twin-screw extruder with co-rotating or contra-rotating screws, of which the barrel and the extrusion/granulation head can be heated to the predetermined extrusion temperature. Under the shear effect of the extruder screws, the premix is compacted under a pressure of preferably at least 25 bar or—with extremely high throughputs—even lower, depending on the apparatus used, plasticized, extruded in the form of fine strands through the multiple-bore extrusion die in the extruder head and, finally, size-reduced by means of a rotating cutting blade, preferably into substantially spherical or cylindrical granules. The bore diameter of the multiple-bore extrusion die and the length to which the strands are cut are adapted to the selected granule size. In this embodiment, granules are produced in a substantially uniformly predeterminable particle size, the absolute particle sizes being adaptable to the particular application envisaged. In general, particle diameters of up to at most 0.8 cm are preferred. It may be preferred not to carry out any drying after the compacting step. Alternatively, extrusion/compression steps may also be carried out in low-pressure extruders, in a Kahl press (manufacturer: Amandus Kahl) or in a so-called Bextruder (manufacturer: Bepex). In one preferred embodiment of the invention, the temperature prevailing in the transition section of the screw, the pre-distributor and the extrusion die is controlled in such a way that the melting temperature of the binder or rather the upper limit to the melting range of the binder is at least reached and preferably exceeded. The temperature exposure time in the compression section of the extruder is preferably less than 2 minutes and, more particularly, between 30 seconds and 1 minute.

The compositions according to the invention may also be produced by roll compacting. In this variant, the premix is introduced between two rollers—either smooth or provided with depressions of defined shape—and rolled under pressure between the two rollers to form a sheet-like compactate. The rollers exert a high linear pressure on the premix and may be additionally heated or cooled as required. The sheet-like compactate is then broken up into smaller pieces by a chopping and size-reducing process and can thus be processed to granules which can be further refined by further surface treatment processes known per se. In roll compacting, too, the temperature of the pressing tools, i.e. the rollers, is preferably at most 150° C., more preferably at most 100° C., and most preferably at most 75° C.

The compositions according to the invention may also be produced by pelleting. In this process, the premix is applied to a perforated surface and is forced through the perforations and at the same time plasticized by a pressure roller. In conventional pellet presses, the premix is compacted under pressure, plasticized, forced through a perforated surface in the form of fine strands by means of a rotating roller and, finally, is size-reduced to granules by a cutting unit. The pressure roller and the perforated die may assume many different forms. For example, flat perforated plates are used, as are concave or convex ring dies through which the material is pressed by one or more pressure rollers. In pelleting, too, the temperature of the pressing tools, i.e. the pressure rollers, is preferably at most 150° C., more preferably at most 100° C., and most preferably at most 75° C.

The present invention also relates to a process for the production of solid detergents, in which a premix containing builders, bleaching agents, complexing agents and additives is first prepared in known manner, and the desired granular solid composition of the invention described in the foregoing is then added to the premix.

The present invention further relates to the use of the composition described in the foregoing for the production of solid detergents and to the use of the composition for improving the clear rinse performance of compositions for cleaning hard surfaces, more particularly automatic dish detergents. It has surprisingly been found that the use of the granular compositions according to the present invention in the production of detergents leads to advantageous performance properties. Improved filming and spotting behavior is particularly accomplished with the use of the compositions of the invention. The terms “filming” and “spotting” denote deposits on hard surfaces after contact with detergents. Spotting is caused by drying water droplets, calcium and magnesium salts, in particular, being precipitated and forming corresponding troublesome deposits. The term filming is used to denote layers formed by the drying of thin films of water. So far as these two key deposits are concerned, it has now demonstrated that the use of selected granules, as described in the foregoing, produces an improvement when used in the production of detergents. In particular, there was an improvement in clear rinse performance on glass surfaces. It was also found that the use of the granular compositions in the production of detergents, more particularly dish detergents, results in products which generate little foam and, hence, have no adverse effect on cleaning performance in automatic dishwashers.

In a preferred embodiment of the invention, these surfactant granules have a grain size distribution between 0.02 and 2.0 mm and, more particularly, between 0.2 and 1.6 mm. In another preferred embodiment of the invention, at least 70%, preferably 75%, and more particularly 85% by weight of the granules comprise round grains.

The following examples are illustrative of the present invention and the improvements achieved therein, and should not be construed in any manner as limiting the scope of the invention.

### EXAMPLES

Several types of surfactant granules were produced. The grain size distributions of the granules used in the Examples were determined by sieve analysis as described hereinafter:
Sieving machine: AS 200 Control (Retsch)
Analysis sieves conforming to DIN ISO 3310-1 (Retsch)
h=25 mm; diameter 200 mm
amplitude: 0.6
sieving time: 2 mins.

The parameters dₘ; d_{63.3} and n, which define the granulometry of the granules, were determined from the grain size distributions obtained by the sieve analysis using the following formula:

$${d}_{m} = \frac{{\sum }_{υ = 1}^{n} {m}_{υ} \overline{{d}_{υ}}}{Z}$$

d̅ᵥ̅=mean grain diameter of the v-th fraction
mᵥ=-weight of a grain fraction
Z=total weight of all grain fractions
v=grain fraction
dₘ=mean diameter

From the evaluation of the grain size distribution using an RRSB (Rosin, Rammler, Sperling, Bennet) distribution graph, the following parameters can be determined:
d_{63.3}=d′ characteristic grain size
n=uniformity coefficient (exponent n)
dₘ=mean diameter

In cases where the granulometric state of the aggregate cannot be described by an RRSB distribution, as for example in the case of mixtures of aggregates differing in granulometry, the above-mentioned parameters also apply to sections of the distribution which follow the RRSB distribution.

Surfactant granules with different grain size distributions were mixed in a general formulation for an automatic dish detergent (ADD) and used in quantities of 25 g for dishwasher tests for testing the properties in ADD applications.

General Formulation:

| Substance | % by weight |
|---|---|
| Surfactant | Up to 4 |
| Sodium silicate (SKS-6) | 7 |
| Na₅ tripolyphosphate | 51 |
| TAED (tetraacetyl ethylene | 2.5 |
| diamine) | |
| Sodium carbonate | 27.5 |
| Sodium percarbonate | 8 |

Test Conditions:
Miele G 661 SC dishwasher, program: 55° C.—Universal Plus
Water hardness: 16° C. dH, substrates/machine load:
   glass plates
   china plates
   polypropylene plates (PP)
   melamine plates
   styrene/acrylonitrile (SAN) plates
   stainless steel plates

46.55 g standard soil (based on 1000 g: mixture of 25 g ketchup, 25 g mustard and 25 g gravy, 300 g margarine, 150 g drinking milk, 15 g potato starch, 9 g egg yolk, 3 g benzoic acid, rest water) were used as the test soil.

After the machine program had finished, the substrates were removed and evaluated for clear rinse performance (filming and spotting) by digital image analysis. The digital image analysis process conforms to the specification of European patent application 04021958.6 (Cognis).

Substrates of glass, steel, plastic and melamine, for example, were evaluated. The spotting and filming values were expressed as relative surface coverages. Higher values for spotting and filming correspond to poorer clear rinse performance of the surfactant granules.

Table 1 shows the results obtained for various surfactant granules. All surfactants are present in quantities of 2% in the formulation.

The following surfactants were tested:

| | |
|---|---|
| C°16/18 40EO | Hydroxy mixed ether based on a C₁₆₋₁₈ fatty |
| | alcohol reacted with 40 mol ethylene oxide per |
| | mol fatty alcohol (Cognis) |
| C18 80EO: | C₁₈ fatty alcohol containing 80 mol ethylene oxide |
| | per mol fatty alcohol |
| C16/18 FA F0 EO: | C₁₆₋₁₈ fatty alcohol reacted with 20 mol ethylene |
| | oxide per mol fatty alcohol |
| C 22 FA 10 EO | C₁₆₋₁₈ fatty alcohol reacted with 20 mol ethylene |
| | oxide per mol fatty alcohol |
| Alkyl glycoside: | C₁₂₋₁₆ fatty alcohol-1,4-glucoside (Cognis) |

In Table 1 below, granules according to the invention (Examples 1 to 5) are compared with granules which had been produced by coating granules based on the general formulation with the surfactant in molten form. The granules of Example 6 were inferior to the granules of Examples 1 to 5 according to the invention in their performance properties with regard to spotting and filming.

TABLE 1

| | | Granulometry of the | | |
|---|---|---|---|---|
| Example | Surfactant | surfactant granules | Filming in %* | Spotting in % |
| 1 | C16/18 40 EO | d < 0.4 mm: 29.8% | Glass: 68 | Glass: 3 |
| | | d ≧ 1.6 mm: 10.6% | | Steel: 0.9 |
| | | dₘ = 0.71 mm | | Melamine: 0.8 |
| | | d′ = 0.79 mm | | |
| | | n = 1.49 | | |
| 2 | C16/18 40 EO | d < 0.4 mm: 99.3% | Glass: 88 | Glass: 4 |
| | | d ≧ 1.6 mm: 0% | | Steel: 1.4 |
| | | dₘ = 0.13 mm | | Melamine: 5.7 |
| | | d′ = 0.09 mm | | |
| | | n = 8.5 | | |
| 3 | C16/18 40 EO | d < 0.4 mm: 0% | Glass: 86 | Glass: 3.8 |
| | | d ≧ 1.6 mm: 42.1% | | Steel: 0.8 |
| | | dₘ = 1.28 mm | | Melamine: 4.3 |
| | | d′ = 1.32 mm | | |
| | | n = 13 | | |
| 4 | C16/18 40 EO | d < 0.4 mm: 22.6% | Glass: 99 | Glass: 4.5 |
| | | d ≧ 1.6 mm: 0% | | Steel: 1.2 |
| | | dₘ = 0.69 mm | | Melamine: 5.8 |
| | | d′ = 0.80 mm | | |
| | | n = 2.0 | | |
| 5 | C16/18 40 EO | d < 0.4 mm: 50.0% | Glass: 82 | Glass: 4.1 |
| | | d ≧ 1.6 mm: 19.6% | | Steel: 1 |
| | | dₘ = 0.69 mm | | Melamine: 4.8 |
| | | 1:1 mixture of surfactant | | |
| | | fractions 2 and 3 | | |
| 6 | C16/18 40 EO | Melted and sprayed onto | Glass: 85 | Glass: 5.2 |
| | | the ADD granules | | Steel: 1 |
| | | | | Melamine: 4.2 |

The results for granules according to the invention (Example 8) and comparison granules (Example 7) are set out in Table 2. The dₘ and d′ values of the granules of Example 7 are below the limits according to the invention. As can be seen, this leads to a distinct difference in the performance properties of the granules.

TABLE 2

| | | Granulometry of the | Filming | Spotting |
|---|---|---|---|---|
| Example | Surfactant | surfactant granules | in %* | in % |
| 7 | C18 80 EO | d < 0.4 mm: na | Glass: 81 | Glass: 5 |
| | | d ≧ 1.6 mm: na | | PP: 11.6 |
| | | dₘ = 0.16 mm | | Melamine: |
| | | d′ = 0.17 mm | | 3.5 |
| | | n = 5.3 | | |
| 8 | C18 80 EO | d < 0.4 mm: 33.6% | Glass: | Glass: 3.7 |
| | | d ≧ 1.6 mm: 19.3% | 17.5 | PP: 6.5 |
| | | dₘ = 0.75 mm | | Melamine: |
| | | d′ = 0.82 mm | | 0.9 |
| | | n = 1.25 | | |

Table 3 shows the data of two granule types, an alkyl (oligo)glycoside being used as the nonionic surfactant. The granules of Example 9 have good performance properties whereas the granules of Example 10, which were produced by spraying the APG/fatty alcohol mixture onto the granulated general formulation, show disadvantages in their performance properties.

TABLE 3

| | | Granulometry of the | Filming in | |
|---|---|---|---|---|
| Example | Surfactant | surfactant granules | %* | Spotting in % |
| 9 | Alkyl polyglucoside/ | d < 0.4 mm: 29.9% | Glass: 38 | Glass: 3.5 |
| | C22 fatty | d ≧ 1.6 mm: 21.4% | | Steel: 3.9 |
| | alcohol mixture | dₘ = 0.79 mm | | Melamine: 2.5 |
| | | d′ = 0.90 mm | | |
| | | n = 1.3 | | |
| 10 | Alkyl polyglucoside/ | Melted and sprayed | Glass: 85 | Glass: 7 |
| | C22 fatty | onto the ADD granules | | Steel: 5.9 |
| | alcohol mixture | | | Melamine: 8.3 |

Table 4 shows the results for comparison granules (Example 11) and granules according to the invention (Example 12). It is again demonstrated that the choice of a certain granulometry leads to better performance results.

TABLE 4

| | | Granulometry of the | Filming in | Spotting |
|---|---|---|---|---|
| Example | Surfactant | surfactant granules | %* | in % |
| 11 | C22 FA 10 EO | Melted and sprayed | Glass: 33 | Glass: 4.7 |
| | | onto the ADD | | PP: 4.9 |
| | | granules | | Melamine: |
| | | | | 11.1 |
| 12 | C22 FA 10 EO | d < 0.4 mm: 1.6% | Glass: 8.3 | Glass: 2 |
| | | d ≧ 1.6 mm: 43.6% | | PP: 4.5 |
| | | dₘ = 1.25 mm | | Melamine: |
| | | d′ = 1.40 mm | | 1.8 |
| | | n = 2.79 | | |

Table 5 shows the data for granules containing ethoxylated fatty alcohols, wherein Example 13 represents comparison granules and Example 14 represents granules of the invention. The improved results achieved by the invention with respect to decreasing the undesirable filming and spotting of the test substrates are again demonstrated.

TABLE 5

| | | Granulometry of the | | |
|---|---|---|---|---|
| Example | Surfactant | surfactant granules | Filming in %* | Spotting in % |
| 13 | C16/18 FA 20 EO | Melted and sprayed | Glass: 75 | Glass: 5.1 |
| | | onto the ADD granules | | PP: 5.2 |
| | | | | Melamine: 14.5 |
| 14 | C16/18 FA 20 EO | d < 0.4 mm: 10.8% | Glass: 8 | Glass: 3.1 |
| | | d ≧ 1.6 mm: 21.0% | | PP: 3.0 |
| | | dₘ = 0.94 mm | | Melamine: 2.0 |
| | | d′ = 1.07 mm | | |
| | | n = 2.67 | | |

*With digital evaluation, filming is only possible in the case of glass in view of the measuring arrangement.

The above Examples show that the granule forms obtained by way of the invention have a distinctly better clear rinse performance than larger or smaller particles. In addition, the clear rinse performance results indicate that there were no foam problems during the wash cycle. Visual examination 10, 20, 30 and 40 minutes after the start of the wash program showed that the foam level at no time affected the performance of the dishwasher.

What we claim is:

1. A solid granular composition comprising at least one surfactant, wherein, according to sieve analysis with a sieve conforming to DIN ISO 3310-1, the granular composition has a grain size distribution, the grain size distribution, as determined by RRSB graph to DIN 66145, having the following parameters:
dₘ ranges from 0.5 to 1.5 mm;
d_{63.3} ranges from 0.5 to 1.5 mm; and
n ranges from 1 to 10.

2. A composition as claimed in claim 1, wherein dₘ ranges from 0.5 to 1.2 mm; d_{63.3} ranges from 0.5 to 1.0 mm and n ranges from 1 to 5.

3. A composition as claimed in claim 1, wherein the composition contains one surfactant.

4. A composition as claimed in claim 1, wherein the surfactant is a nonionic surfactant.

5. A composition as claimed in claim 4, wherein the nonionic surfactant is selected from at least one member of the following groups a) to i):
a) a compound corresponding to formula (I):
R¹O[CH₂CH₂O]ₓCH₂CH(OM)R² (I)
in which R¹ is a linear or branched alkyl and/or alkenyl group containing 4 to 22 carbon atoms or an R²—CH(OH)CH₂ group, wherein R² is a linear or branched alkyl and/or alkenyl group containing 8 to 16 carbon atoms, x is a number from 40 to 80, and M is a hydrogen atom or a saturated alkyl group containing 1 to 18 carbon atoms;
b) a compound corresponding to formula (II):
R³O[CH₂CH₂O]_{y}[CH₂CHCH₃O]_{z}—CH₂CH(OH)R⁴ (II)
in which R³ is a linear or branched alkyl and/or alkenyl group containing 8 to 22 carbon atoms, R⁴ is a linear or branched alkyl and/or alkenyl group containing 8 to 16 carbon atoms, y is a number from 10 to 35, z=0 or a number from 1 to 5, with the proviso that, where R³═R¹ and at the same time R⁴═R², z is at least 1;
c) an ethoxylated fatty alcohol corresponding to formula (III):
R⁵—(OC₂H₄)—OH (III)
in which R⁵ represents a linear or branched alkyl and/or alkenyl group containing 8 to 22 carbon atoms and z is a number from 1 to 20;
d) a compound corresponding to formula (IV):
R⁶CO—(OC₂H₄)ₘ—OR⁷ (IV)
in which R⁶ represents an alkyl and/or alkenyl group containing 7 to 21 carbon atoms, and m is a number from 11 to 100, and R⁷ is a hydrogen atom or a CO—R⁶ group;
e) an alkyl (oligo)glycoside corresponding to the formula R⁸O-[G]ₚ, wherein R⁸ is an alkyl and/or alkenyl group containing 4 to 22 carbon atoms, G is a sugar unit containing 5 or 6 carbon atoms, and p is a number from 1 to 10;
f) a betaine;
g) a compound corresponding to formula (V): 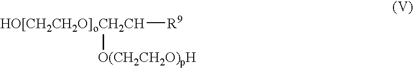
in which R⁹ is a saturated or unsaturated, branched or unbranched alkyl or alkenyl group containing 8 to 16 carbon atoms, and the substituents R¹¹ independently of one another represent a group (CH₂CH₂O)ᵣCH₂CH(OH)R¹², r in each substituent R¹¹ independently being 0 or a number from 1 to 50, and R¹² being a saturated or unsaturated, branched or unbranched alkyl or alkenyl group containing 8 to 16 carbon atoms;
i) a compound corresponding to formula (VII):
NR¹³₃ (VII)
in which the substituents R¹³ independently of one another represent a (CH₂CH₂O)ₛCH₂CH(OH)R¹⁴ group or an alkyl group containing 8 to 16 carbon atoms, and s for each substituent R¹³ independently represents 0 or a number from 1 to 50;
and mixtures of compounds a) to i) thereof.

6. A composition as claimed in claim 5, which consists of one nonionic surfactant selected from the groups of a) to i).

7. A composition as claimed in claim 5, wherein the nonionic surfactant is selected from the group consisting of group a) and group b), or a combination thereof.

8. A solid cleaning composition which comprises a solid granular composition comprising at least one surfactant, wherein, according to sieve analysis with a sieve conforming to DIN ISO 3310-1, the granular composition has a grain size distribution, the grain size distribution, as determined by RRSB graph to DIN 66145, having the following parameters:
dₘ ranges from 0.5 to 1.5 mm;
d_{63.3} ranges from 0.5 to 1.5 mm; and
n ranges from 1 to 10.

9. A solid cleaning composition as claimed in claim 8, wherein the solid granular composition is present in an amount of from 0.1 to 25% by weight, based on the total weight of the cleaning composition.

10. A solid cleaning composition as claimed in claim 9, wherein the solid granular composition is present in an amount of from 0.5 to 15% by weight.

11. A solid cleaning composition as claimed in claim 10, wherein the solid granular composition is present in an amount of from 1 to 5% by weight.

12. A solid cleaning composition as claimed in claim 8, wherein dₘ ranges from 0.5 to 1.2 mm; d_{63.3} ranges from 0.5 to 1.0 mm and n ranges from 1 to 5.

13. A solid cleaning composition as claimed in claim 8, wherein the surfactant of the solid granular composition is a nonionic surfactant.

14. A solid cleaning composition as claimed in claim 13, wherein the nonionic surfactant is selected from at least one member of the following groups a) to i):
a) a compound corresponding to formula (I):
R¹O[CH₂CH₂O]ₓCH₂CH(OM)R² (I)
in which R¹ is a linear or branched alkyl and/or alkenyl group containing 4 to 22 carbon atoms or an R²—CH(OH)CH₂ group, wherein R² is a linear or branched alkyl and/or alkenyl group containing 8 to 16 carbon atoms, x is a number from 40 to 80, and M is a hydrogen atom or a saturated alkyl group containing 1 to 18 carbon atoms;
b) a compound corresponding to formula (II):
R³O[CH₂CH₂O]_{y}[CH₂CHCH₃O]_{z}CH₂CH(OH)R⁴ (II)
in which R³ is a linear or branched alkyl and/or alkenyl group containing 8 to 22 carbon atoms, R⁴ is a linear or branched alkyl and/or alkenyl group containing 8 to 16 carbon atoms, y is a number from 10 to 35, z=0 or a number from 1 to 5, with the proviso that, where R³R¹ and at the same time R⁴═R², z is at least 1;
c) an ethoxylated fatty alcohol corresponding to formula (III):
R⁵—(OC₂H₄)_{z}—OH (III)
in which R⁵ represents a linear or branched alkyl and/or alkenyl group containing 8 to 22 carbon atoms and z is a number from 1 to 20;
d) a compound corresponding to formula (IV)
R⁶CO—(OC₂H₄)ₘ—OR⁷ (IV)
in which R⁶ represents an alkyl and/or alkenyl group containing 7 to 21 carbon atoms, and m is a number from 11 to 100, and R⁷ is a hydrogen atom or a CO—R⁶ group;
e) an alkyl (oligo)glycoside corresponding to the formula R⁸O-[G]ₚ, wherein R⁸ is an alkyl and/or alkenyl group containing 4 to 22 carbon atoms, G is a sugar unit containing 5 or 6 carbon atoms, and p is a number from 1 to 10;
f) a betaine;
g) a compound corresponding to formula (V):, 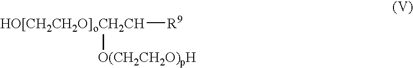
in which R⁹ is a linear or branched alkyl and/or alkenyl group containing 4 to 22 carbon atoms, o is a number from 1 to 20, and p is 0 or a number from 1 to 20;
h) a compound corresponding to formula (VI):
R¹⁰CH(OR¹¹)CH₂—OR¹¹ (VI)
in which R¹⁰ is a saturated or unsaturated, branched or unbranched alkyl or alkenyl group containing 8 to 16 carbon atoms, and the substituents R¹¹ independently of one another represent a group (CH₂CH₂O)ᵣCH₂CH(OH)R¹², r in each substituent R¹¹ independently being 0 or a number from 1 to 50, and R¹² being a saturated or unsaturated, branched or unbranched alkyl or alkenyl group containing 8 to 16 carbon atoms;.
i) a compound corresponding to formula (VII):
NR¹³₃ (VII)
in which the substituents R¹³ independently of one another represent a (CH₂CH₂O)ₛCH₂CH(OH)R¹⁴ group or an alkyl group containing 8 to 16 carbon atoms, and s for each substituent R¹³ independently represents 0 or a number from 1 to 50;
and mixtures of compounds a) to i) thereof.

15. A solid cleaning composition as claimed in claim 14, wherein the nonionic surfactant consists of one surfactant selected from the groups of a) to i).

16. A solid cleaning composition as claimed in claim 14, wherein the nonionic surfactant is selected from the group consisting of group a) and group b), or a combination thereof.
